(19) United States
(12) Patent Application Publication
(10) Pub. No.: US 2026/0303157 A1
(43) Pub. Date: Oct. 1, 2026

(54) METHOD AND APPARATUS FOR COMMUNICATION BASED ON PRECODING

(71) Applicant: BEIJING XIAOMI MOBILE SOFTWARE CO., LTD., Beijing (CN)

(72) Inventors: Gaoming DUAN, Beijing (CN); Liangang CHI, Beijing (CN)

(21) Appl. No.: 19/476,956

(22) PCT Filed: Apr. 20, 2023
(86) PCT No.: PCT/CN2023/089617

§ 371 Date: Oct. 20, 2025

(51) Int. Cl. H04B 7/0456

(52) U.S. Cl. CPC H04B 7/0456

(57) ABSTRACT

A method for communication based on precoding, performed by a network device, including: determining a codebook used by a terminal from at least two sets of candidate codebooks, where the at least two sets of candidate codebooks include a first codebook applicable to far-field communication and a second codebook applicable to near-field communication; and sending first indication information to the terminal, where the first indication information indicates the codebook used by the terminal.

### CROSS-REFERENCE TO RELATED APPLICATIONS

This application is the US national phase application of International Application No. PCT/CN2023/089617 filed on Apr. 20, 2023, the entire contents of which are incorporated herein by reference.

### TECHNICAL FIELD

The disclosure relates to the field of communication technologies, and in particular to a method and an apparatus for communication based on precoding.

### BACKGROUND

In a high-frequency communication system, a higher frequency band leads to a greater Rayleigh distance and a shorter wavelength. This results in a smaller channel capacity when a plane wave model is used for modeling in a near field, whereas a spherical wave model exhibits better channel capacity performance in near-field communication at high frequency bands. Thus, in the future, corresponding precoding may need to be designed respectively for different scenarios of the far field and the near field to maximize a system capacity. However, movement of a user may cause the user to switch between the communication scenarios of the far field and the near field.

### SUMMARY

According to a first aspect of embodiments of the disclosure, a method for communication based on precoding is provided. The method is performed by a network device, and includes: determining a codebook used by a terminal from at least two sets of candidate codebooks, in which the at least two sets of candidate codebooks at least include a first codebook applicable to far-field communication and a second codebook applicable to near-field communication; and sending first indication information to the terminal, in which the first indication information indicates the codebook used by the terminal.

According to a second aspect of embodiments of the disclosure, a method for communication based on precoding is provided. The method is performed by a terminal, and includes: receiving first indication information sent by a network device, in which the first indication information indicates a codebook used by the terminal, the codebook used by the terminal is determined by the network device from at least two sets of candidate codebooks, and the at least two sets of candidate codebooks at least include a first codebook applicable to far-field communication and a second codebook applicable to near-field communication.

According to a third aspect of embodiments of the disclosure, a network device is provided. The network device includes a processor and a memory storing a computer program executable by the processor. The processor is configured to: determine a codebook used by a terminal from at least two sets of candidate codebooks, in which the at least two sets of candidate codebooks at least include a first codebook applicable to far-field communication and a second codebook applicable to near-field communication; and send first indication information to the terminal, in which the first indication information indicates the codebook used by the terminal.

According to a fourth aspect of embodiments of the disclosure, a terminal is provided. The terminal includes a processor and a memory storing a computer program executable by the processor. The processor is configured to perform the method described in the second aspect.

Additional aspects and advantages of the disclosure will be set forth in part in the description which follows, and in part will be obvious from the description, or will be learned by practice of the disclosure.

### BRIEF DESCRIPTION OF THE DRAWINGS

In order to explain technical solutions in the embodiments of the disclosure or the related art more clearly, the figures described in the embodiments of the disclosure or required in the related art will be briefly introduced below.

FIG. 1a is a diagram illustrating an architecture of a communication system according to an embodiment of the disclosure.

FIG. 1b is a schematic diagram illustrating channel capacities of different electromagnetic wave modeling at different frequencies according to an embodiment of the disclosure.

FIG. 2 is a flow chart illustrating a method for communication based on precoding applicable to a network device according to an embodiment of the disclosure.

FIG. 3 is a flow chart illustrating a method for communication based on precoding according to an embodiment of the disclosure.

FIG. 4 is a flow chart illustrating a method for communication based on precoding according to an embodiment of the disclosure.

FIG. 5 is a flow chart illustrating a method for communication based on precoding applicable to a terminal according to an embodiment of the disclosure.

FIG. 6 is a flow chart illustrating a method for communication based on precoding according to an embodiment of the disclosure.

FIG. 7 is a flow chart illustrating a method for communication based on precoding according to an embodiment of the disclosure.

FIG. 8 is a block diagram illustrating an apparatus for communication based on precoding according to an embodiment of the disclosure.

FIG. 9 is a block diagram illustrating an apparatus for communication based on precoding according to an embodiment of the disclosure.

FIG. 10 is a block diagram illustrating an apparatus for communication based on precoding according to an embodiment of the disclosure.

FIG. 11 is a block diagram illustrating a chip according to an embodiment of the disclosure.

### DETAILED DESCRIPTION

Reference will now be made in detail to the example embodiments, examples of which are illustrated in the accompanying figures. When the following description refers to the accompanying figures, the same numerals in different figures refer to the same or similar elements, unless otherwise indicated. The implementations described in the following example embodiments do not represent all implementations consistent with embodiments of the disclosure. Rather, they are merely examples of devices and methods consistent with some aspects of embodiments of the disclosure as recited in the appended claims.

Terms used in the embodiments of the disclosure are for the purpose of describing specific embodiments only, and are not intended to limit the embodiments of the disclosure. As used in the embodiments of the disclosure and the appended claims, the singular forms “a/an” and “the” are also intended to include the plural forms, unless the context clearly dictates otherwise. It should also be understood that the term “and/or” as used herein refers to and includes any and all possible combinations of one or more of the associated listed items.

It should be understood that although the embodiments of the disclosure may use the terms first, second, third, etc. to describe various information, the information should not be limited to these terms. These terms are only used to distinguish information of the same type from one another. For example, without departing from the scope of the embodiments of the disclosure, first information may also be called second information, and similarly, second information may also be called first information. Depending on the context, the word “if” and “in case of” as used here may be interpreted as “in a case that” or “when” or “in response to determining that”.

Embodiments of the disclosure are described in detail below, and examples of the embodiments are illustrated in the accompanying figures, throughout which the same or similar symbols indicate the same or similar elements. The embodiments described below with reference to the accompanying figures are examples and are intended to be used to explain the disclosure and are not to be construed as a limitation of the disclosure.

In order to better understand the method for communication based on precoding in embodiments of the disclosure, a communication system to which the embodiments of the disclosure are applicable is described below.

Referring to FIG. 1a, it is a diagram illustrating an architecture of a communication system according to an embodiment of the disclosure. The communication system may include, but is not limited to, one network device and one terminal. The number and forms of the devices illustrated in FIG. 1a are only for example and do not constitute a limitation to embodiments of the disclosure, and two or more network devices and two or more terminals may be included in practical applications. The communication system as illustrated in FIG. 1a includes one network device 101, and one terminal 102 for example.

It needs to be noted that the technical solution in embodiments of the disclosure is applicable to various communication systems, for example, a long term evolution (LTE) system, a 5th generation (5G) mobile communication system, a 5G new radio (NR) system or other future new mobile communication systems.

The network device 101 in embodiments of the disclosure is a network-side entity for transmitting or receiving a signal. For example, the network device 101 may be an evolved NodeB (eNB), a transmission reception point (TRP), a next generation NodeB (gNB) in a NR system, a base station in other future mobile communication systems, or an access node in a wireless fidelity (WiFi) system. A specific technology and a specific device form adopted by the network device are not limited in embodiments of the disclosure. The network device according to the embodiments of the disclosure may consist of a central unit (CU) and a distributed unit (DU). The CU may also be referred to as a control unit. A protocol layer of the network device, such as a base station, may be split by using a structure of the CU-DU, so that functions for a part of the protocol layer are placed in the CU for centralized control, and functions of a remaining part or all of the protocol layer are distributed in the DU, and the DU is centrally controlled by the CU.

The terminal 102 in the embodiments of the disclosure is a user-side entity for receiving or transmitting a signal, for example, a mobile phone. The terminal may be referred to as a user equipment (UE), a mobile station (MS), a mobile terminal (MT), etc. The terminal may be a device with a communication function, such as a vehicle, a smart vehicle, a mobile phone, an Internet of Things device, a wearable device, a tablet computer (Pad), a computer with a wireless transceiving function, a virtual reality (VR) terminal, an augmented reality (AR) terminal, a wireless terminal in industrial control, a wireless terminal in self-driving, a wireless terminal in a remote medical surgery, a wireless terminal in a smart grid, a wireless terminal in transportation safety, a wireless terminal in a smart home, etc. A specific technology adopted by the terminal and a specific device form adopted by the terminal are not limited in the embodiments of the disclosure.

In some embodiments, names of information and the like are not limited to the names recorded in the embodiments, and terms such as “information”, “message”, “signal”, “signaling”, “report”, “configuration”, “indication”, “instruction”, “command”, “channel”, “parameter”, “field”, “symbol”, “codebook”, “codeword”, “codepoint”, “bit”, “data”, “program”, and “chip” may be used interchangeably.

In some embodiments, terms such as “codebook”, “codeword”, and “precoding matrix” may be used interchangeably. For example, a codebook may be a collection of one or more codewords/precoding matrices.

In some embodiments, terms such as “uplink”, “up-link”, “physical uplink” may be used interchangeably; terms such as “downlink”, “down-link”, “physical downlink” may be used interchangeably; and terms such as “side”, “sidelink”, “side communication”, “sidelink communication”, “direct connection”, “direct link”, “direct communication”, “direct link communication” may be used interchangeably.

In some embodiments, terms such as “downlink control information (DCI)”, “downlink (DL) assignment”, “DL DCI”, “uplink (UL) grant”, and “UL DCI” may be used interchangeably.

In some embodiments, terms such as “physical downlink shared channel (PDSCH)” and “DL data” may be used interchangeably; terms such as “physical uplink shared channel (PUSCH)” and “UL data” may be used interchangeably.

In some embodiments, terms such as “radio”, “wireless”, “radio access network (RAN)”, “access network (AN)”, and “RAN-based” may be used interchangeably.

In some embodiments, terms such as “search space (SS)”, “search space set”, “search space configuration”, “search space set configuration”, “control resource set (CORESET)”, and “CORESET configuration” may be used interchangeably.

In some embodiments, terms such as “synchronization signal (SS)”, “synchronization signal block (SSB)”, “reference signal (RS)”, “pilot”, and “pilot signal” may be used interchangeably.

In some embodiments, terms such as “moment”, “time point”, “time”, and “time location” may be used interchangeably; terms such as “time length”, “time period”, “time window”, “window”, and “time” may be used interchangeably.

In some embodiments, terms such as “component carrier (CC)”, “cell”, “frequency carrier”, and “carrier frequency” may be used interchangeably.

In some embodiments, terms such as “resource block (RB)”, “physical resource block (PRB)”, “sub-carrier group (SCG)”, “resource element group (REG)”, “PRB pair”, “RB pair”, and “resource element (RE)” may be used interchangeably.

In some embodiments, terms such as “wireless access scheme” and “waveform” may be used interchangeably.

In some embodiments, terms such as “precoding”, “precoder”, “weight”, “precoding weight”, “quasi-co-location (QCL)”, “transmission configuration indication (TCI) state”, “spatial relation”, “spatial domain filter”, “transmission power”, “phase rotation”, “antenna port”, “antenna port group”, “layer”, “the number of layers”, “rank”, “resource”, “resource set”, “resource group”, “beam”, “beam width”, “beam angular degree”, “antenna”, “antenna element”, and “panel” may be used interchangeably.

In some embodiments, terms such as “frame”, “radio frame”, “subframe”, “slot”, “sub-slot”, “mini-slot”, “symbol”, and “transmission time interval (TTI)” may be used interchangeably.

In some embodiments, “acquire”, “obtain”, “get”, “receive”, “transmit”, “bidirectional transmission”, and “send and/or receive” may be used interchangeably, which may be interpreted as receiving from another entity, acquiring from a protocol, obtaining via own processing, autonomous implementation, and other meanings.

In some embodiments, terms such as “send”, “transmit”, “report”, “deliver”, “transmit”, “bidirectional transmission”, and “send and/or receive” may be used interchangeably.

In some embodiments, “predetermined” and “preset” may be interpreted as pre-defined in a protocol or the like, or may be interpreted as an apparatus performing a pre-configuration action.

In some embodiments, “determining” may be interpreted as, but is not limited to, judging, deciding, adjudicating, calculating, computing, processing, deriving, investigating, searching, looking up, retrieving, inquiring, ascertaining, receiving, transmitting, inputting, outputting, accessing, resolving, selecting, choosing, establishing, comparing, “assuming”, “expecting”, “considering”, broadcasting, notifying, communicating, forwarding, configuring, reconfiguring, allocating, mapping, assigning, etc.

In some embodiments, determination or judgment may be performed by a value represented by 1 bit (0 or 1), may be performed by a truth value (Boolean value) represented by true or false, or may be performed by comparison of numerical values (for example, comparison with a predetermined value), which is not limited here.

In some embodiments, “network” may be interpreted as an apparatus (for example, an access network device, a core network device, or the like) included in the network.

In some embodiments, “not expect to receive” may be interpreted as not receiving on a time domain resource and/or a frequency domain resource, or may be interpreted as not performing subsequent processing on data or the like after receiving the data or the like; “not expect to send” may be interpreted as not sending, or may be interpreted as sending but not expecting a response from a receiver to the sent content.

In some embodiments, obtaining of data, information, or the like may comply with laws and regulations of the country where it is located.

In some embodiments, data, information, or the like may be obtained after user consent is obtained.

Further, each element, each row, or each column in the tables in the embodiments of the disclosure may be implemented as an independent embodiment, and a combination of any elements, any rows, or any columns may also be implemented as an independent embodiment.

With the continuous development of wireless communication, requirements for communication capabilities are becoming increasingly higher. For future application scenarios such as augmented reality (AR)/virtual reality (VR), Internet of Vehicles, and Internet of Things, ultra-high speed, ultra-low latency, and ultra-large bandwidth communication have become the norm. To meet the requirements, more and more new technologies are being proposed.

Terahertz is a potential key technology for 6G. Terahertz communication is considered an important candidate air interface technology for achieving Tera bit per second (Tbps) communication rates in 6G, and is expected to be applied in scenarios such as holographic communication, micro-scale communication, ultra-large capacity data backhaul, and short-range ultra-high-speed transmission.

In a high-frequency communication system, a higher frequency band leads to a greater Rayleigh distance and a shorter wavelength. This results in a smaller channel capacity when a plane wave model is used for modeling in a near field. As shown in FIG. 1b, FIG. 1b illustrates trends of channel capacity performance for a plane wave model (PWM) based on a plane wave and a spherical wave model (SWM) based on a spherical wave at different communication distances and communication frequencies. It may be seen from FIG. 1b that the spherical wave model has better channel capacity performance in the near-field communication at high frequency bands. However, precoding based on the spherical wave has higher complexity, while precoding based on the plane wave is relatively simpler. Thus, in the future, the corresponding precoding may need to be designed respectively for the different scenarios of the far field and the near field to maximize the system capacity. For example, a two-dimensional discrete Fourier transform (DFT) codebook may be used in the far field, while a polar domain codebook may be used in the near field. Furthermore, movement of a user may cause the user to switch between the communication scenarios of the far field and the near field.

In summary, in the high-frequency communication system, there may be the cases that the communication scenario of the far field or the near field where the user is located is switched back and forth. Thus, the corresponding precoding manner may be required to be changed accordingly to ensure channel capacity.

It may be understood that, the communication system described in the embodiments of the disclosure is intended to explain technical solution of the embodiments of the disclosure more clearly, and does not constitute the limitation to the technical solution of the embodiments of the disclosure. Those skilled in the art know that, with evolution of the system architecture and emergence of new service scenarios, the technical solution according to the embodiments of the disclosure are also applicable to similar technical problems.

The method and apparatus for communication based on precoding in the disclosure are further described in combination with the attached figures.

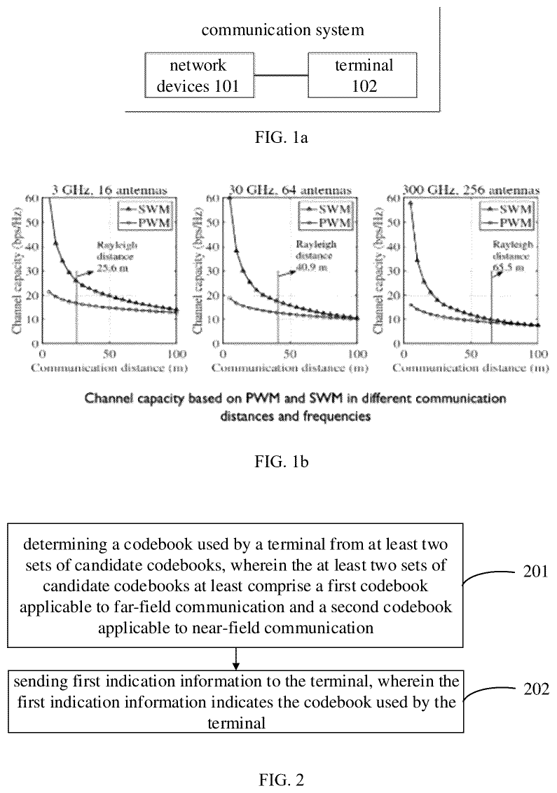

Referring to FIG. 2, it is a flow chart illustrating a method for communication based on precoding according to an embodiment of the disclosure. It needs to be noted that the method for communication based on precoding in the embodiment of the disclosure is performed by a network device. The method may be performed independently or may be performed in conjunction with any other embodiments of the disclosure. As shown in FIG. 2, the method may include the following steps 201 to 202.

At step 201, a codebook used by a terminal is determined from at least two sets of candidate codebooks.

In the embodiment of the disclosure, the at least two sets of candidate codebooks at least include a first codebook applicable to far-field communication and a second codebook applicable to near-field communication. However, it should be understood that the at least two sets of candidate codebooks may further include other specific codebooks, which are not limited in the disclosure, as long as the candidate codebooks include the first codebook corresponding to the far-field communication and the second codebook corresponding to the near-field communication.

In the embodiment of the disclosure, the network device supports the at least two sets of codebooks respectively applicable to different communication scenarios, and is capable of determining the codebook used by the terminal from the at least two sets of candidate codebooks.

The at least two sets of codebooks at least include the first codebook applicable to the far-field communication and the second codebook applicable to the near-field communication.

It should be noted that the far-field communication refers to communication under a condition that the terminal is in the far field, and the near-field communication refers to communication under a condition that the terminal is in the near field. It may be understood that a range in which the terminal is in the far-field condition and a range in which the terminal is in the near-field condition are related to an antenna aperture (antenna array size) of the network device and a communication frequency where the network device is located. For example, a larger antenna array size leads to a larger range of the near-field condition.

As an implementation, for example, the first codebook may be a codebook based on a two-dimensional DFT, and the second codebook may be a codebook based on a polar domain.

In some implementations, the network device may determine, based on the communication scenario where the terminal is located, the codebook used by the terminal from the at least two sets of candidate codebooks. That is, the network device may obtain the communication scenario where the terminal is located, and select a codebook corresponding to the communication scenario where the terminal is located from the candidate codebooks. Specific methods for determining the communication scenario where the terminal is located is described in detail below.

In an implementation, in a case that the terminal is in the far-field communication, the first codebook applicable to the far-field communication is determined as the codebook used by the terminal; and in a case that the terminal is in the near-field communication, the second codebook applicable to the near-field communication is determined as the codebook used by the terminal.

In the embodiment of the disclosure, the network device may determine first information based on an antenna aperture of the network device and/or a communication frequency of the network device, in which the first information is used to distinguish communication scenarios, and the communication scenarios include the far-field communication and the near-field communication.

It should be noted that the antenna aperture refers to an effective area size of an antenna for receiving or transmitting signals, usually measured in meters or square meters.

In an implementation, the first information may be switching threshold information or switching interval information for delimiting the communication scenario where the terminal is located.

In some implementations, the network device may determine information of a distance between the terminal and the network device, and determine the communication scenario where the terminal is located based on the information of the distance and the first information for distinguishing communication scenarios, and further determine the codebook used by the terminal based on the communication scenario where the terminal is located.

In an implementation, the network device may determine the information of the distance between the terminal and the network device based on a sent sensing signal.

In an implementation, the network device may also determine, by calculating, the information of the distance between the terminal and the network device based on parameter information. The parameter information includes at least one of: a pathloss corresponding to the terminal; a timing advance (TA) corresponding to the terminal; or delay information corresponding to the terminal.

In an implementation, the network device may also use the above two manners simultaneously to determine the information of the distance.

As an example, the first information may be the switching threshold information. For example, the first information is a switching threshold x. If a distance between the terminal and the network device is less than the switching threshold x, the terminal is considered to be in the communication scenario of the near-field communication. If the distance between the terminal and the network device is greater than the switching threshold x, the terminal is considered to be in the communication scenario of the far-field communication. If the distance between the terminal and the network device is equal to the switching threshold x, the terminal may be considered to be in the communication scenario of the near-field communication, or may be considered to be in the communication scenario of the far-field communication, which may be determined flexibly by the network device based on an actual situation. Alternatively, it may be agreed that in this case, the communication scenario of the terminal is regarded as a specified one of the far-field communication or the near-field communication.

As another example, the first information may be the switching interval information. For example, the first information is a switching interval [y, z]. If the distance between the terminal and the network device is less than a minimum value y of the switching interval, the terminal is delimited to be in the communication scenario of the near-field communication. If the distance between the terminal and the network device is greater than a maximum value z of the switching interval, the terminal is delimited to be in the communication scenario of the far-field communication. If the distance between the terminal and the network device is within the switching interval [y, z], the terminal may be delimited to be in the communication scenario of the near-field communication, or may be delimited to be in the communication scenario of the far-field communication, which may be determined flexibly by the network device based on an actual situation.

It may be understood that x, y, and z in the above examples are all distances, and y is less than z.

In some implementations, the network device may receive auxiliary information sent by the terminal, and determine, based on the auxiliary information, the codebook used by the terminal from the at least two sets of candidate codebooks. That is, the terminal may send the auxiliary information to the network device to enable the network device to determine a corresponding codebook for the terminal. That is, the network device may determine, based on the auxiliary information provided by the terminal, the codebook used by the terminal from the at least two sets of candidate codebooks.

In an implementation, the auxiliary information includes at least one of: information of a distance between the terminal and the network device; or second indication information, in which the second indication information indicates a recommended codebook of the terminal for a communication scenario where the terminal is located.

In an implementation, the auxiliary information may also include information indicating the communication scenario where the terminal is located, i.e., the terminal determines the communication scenario where the terminal is located and informs the network device via the auxiliary information. Alternatively, the auxiliary information may also be other information that may be used to assist the network device in selecting the codebook used by the terminal, which is not limited in the embodiments of the disclosure.

In an implementation, the auxiliary information may be sent via a physical uplink control channel (PUCCH) or a physcial uplink shared channel (PUSCH). Certainly, the auxiliary information may also be sent via other signaling, which is not limited in the disclosure.

It may be understood that the auxiliary information sent by the terminal is to report a reference distance and/or a recommended codebook to the network device. The network device determines the codebook used by the terminal based on the auxiliary information reported by the terminal. The codebook used by the terminal that is finally determined by the network device may be the same as or different from the recommended codebook in the auxiliary information reported by the terminal.

In an implementation, the network device may also determine the first information based on an antenna aperture of the network device and/or a communication frequency of the network device, and send the first information to the terminal. The first information may be used by the terminal to determine whether the terminal is in the communication scenario of the far-field communication or the communication scenario of the near-field communication. The terminal may also determine the second indication information in the auxiliary information based on the first information, thus determining the recommended codebook for the communication scenario where the terminal is located. That is, the terminal may determine the communication scenario where the terminal is located based on the first information sent by the network device, determine a codebook the terminal expects to use in the communication scenario, and inform the network device of the codebook recommended by the terminal for the current communication scenario via the auxiliary information.

In an implementation, the first information may be the switching threshold information or the switching interval information for delimiting the communication scenario where the terminal is located.

In some implementations, the method may further include step 202.

At step 202: first indication information is sent to the terminal, in which the first indication information indicates the codebook used by the terminal.

In the embodiment of the disclosure, after determining the codebook used by the terminal, the network device may send the first indication information to the terminal, in which the first indication information indicates the codebook used by the terminal.

In some implementations, the first indication information may directly indicate the codebook used by the terminal, or may indicate switching the codebook used by the terminal. The codebook used by the terminal may be indicated using other indication manners, for example, using an implicit indication manner, which is not limited in the embodiments of the disclosure. For example, in a case that the terminal is in the near-field communication, the first indication information may instruct the terminal to use the codebook applicable to the near-field communication, or may instruct the terminal to switch from the codebook applicable to the far-field communication to the codebook applicable to the near-field communication.

In the embodiments of the disclosure, the first indication information may be indicated by any one or more of: a radio resource control (RRC) signaling; a media access control (MAC) control element (CE) signaling; or downlink control information (DCI).

In an implementation, the first indication information may reuse an existing information field or bit, or may use a newly added information field or bit.

In summary, the codebook used by the terminal is determined from the at least two sets of candidate codebooks, in which the at least two sets of candidate codebooks at least include the first codebook applicable to the far-field communication and the second codebook applicable to the near-field communication; and the first indication information is sent to the terminal, in which the first indication information indicates the codebook used by the terminal. This enables the network side to flexibly select and switch the corresponding codebook based on the communication scenario where the terminal is located. In a case of switching between the far-field communication scenario and the near-field communication scenario that may exist in the high-frequency communication system, the channel capacity is effectively improved, the complexity of precoding is reduced, the balance between the complexity of precoding and maximization of channel capacity is achieved, and the reliability of information transmission of the entire communication system is ensured.

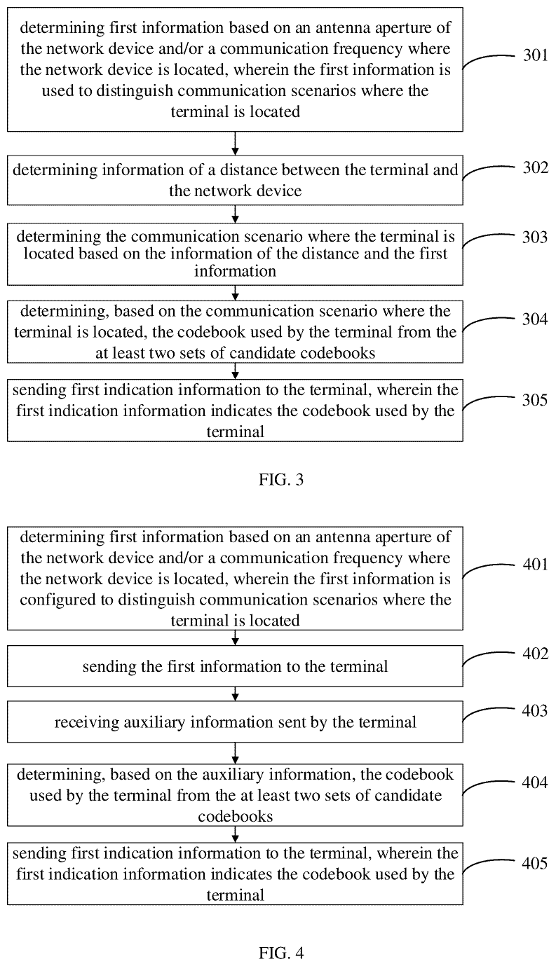

Referring to FIG. 3, it is a flow chart illustrating a method for communication based on precoding according to an embodiment of the disclosure. It needs to be noted that the method for communication based on precoding in the embodiment of the disclosure is performed by a network device. The method may be performed independently or may be performed in conjunction with any other embodiments of the disclosure. As shown in FIG. 3, the method may include the following steps 301 to 305.

At step 301, first information is determined based on an antenna aperture of the network device and/or a communication frequency of the network device, in which the first information is used by the terminal to determine a communication scenario where the terminal is located, and the communication scenario includes a far-field communication and a near-field communication.

In the embodiment of the disclosure, the network device may determine the first information based on the antenna aperture of the network device and/or the communication frequency of the network device, in which the first information is used to distinguish the communication scenarios, and the communication scenarios include the far-field communication and the near-field communication.

It should be noted that the antenna aperture refers to an effective area size of an antenna for receiving or transmitting signals, usually measured in meters or square meters.

In an implementation, the first information may be switching threshold information or switching interval information for delimiting the communication scenario where the terminal is located.

As an example, the first information may be the switching threshold information. For example, the first information is a switching threshold x. The switching threshold x is a boundary for distinguishing whether the terminal is located in the near-field communication or the far-field communication.

In an implementation, if a distance between the terminal and the network device is equal to the switching threshold x, the network device may determine the communication scenario of the terminal flexibly based on an actual situation.

As another example, the first information may be the switching interval information. For example, the first information is a switching interval [y, z]. The switching interval [y, z] is a boundary interval for distinguishing whether the terminal is located in the near-field communication or the far-field communication.

In an implementation, if a distance between the terminal and the network device is within the switching interval [y, z], the network device may determine the communication scenario of the terminal flexibly based on an actual situation.

It may be understood that x, y, and z in the above examples are all distances, and y is less than z.

At step 302, information of a distance between the terminal and the network device is determined.

In some implementations, the network device may determine the information of the distance between the terminal and the network device, and determine the communication scenario where the terminal is located based on the information of the distance and the first information for distinguishing the communication scenarios, and further determine the codebook used by the terminal based on the communication scenario where the terminal is located.

In an implementation, the network device may determine the information of the distance between the terminal and the network device based on a sent sensing signal.

In an implementation, the network device may also determine, by calculating, the information of the distance between the terminal and the network device based on parameter information. The parameter information includes at least one of: a pathloss corresponding to the terminal; a TA corresponding to the terminal; or delay information corresponding to the terminal.

In an implementation, the network device may also use the above two manners simultaneously to determine the information of the distance.

At step 303, the communication scenario where the terminal is located is determined based on the information of the distance and the first information.

In the embodiment of the disclosure, the network device may determine the communication scenario where the terminal is located based on the information of the distance and the first information, and further determine the codebook used by the terminal.

As an example, the first information may be the switching threshold information. For example, the first information is a switching threshold x (e.g., x may be 25 meters). If a distance between the terminal and the network device is less than the switching threshold x, the terminal is considered to be in the communication scenario of the near-field communication. If the distance between the terminal and the network device is greater than the switching threshold x, the terminal is considered to be in the communication scenario of the far-field communication. If the distance between the terminal and the network device is equal to the switching threshold x, the terminal may be considered to be in the communication scenario of the near-field communication, or may be delimited to be in the communication scenario of the far-field communication, which may be determined by the network device flexibly based on an actual situation.

As another example, the first information may be the switching interval information. For example, the first information is a switching interval [y, z] (e.g., y-z may be [20, 25] meters). If the distance between the terminal and the network device is less than the minimum value y of the switching interval, the terminal is delimited to be in the communication scenario of the near-field communication. If the distance between the terminal and the network device is greater than the maximum value z of the switching interval, the terminal is delimited to be in the communication scenario of the far-field communication. If the distance between the terminal and the network device is within the switching interval [y, z], the terminal may be delimited to be in the communication scenario of the near-field communication, or may be delimited to be in the communication scenario of the far-field communication, which may be determined by the network device flexibly based on an actual situation.

It may be understood that x, y, and z in the above examples are all distances, and y is less than z.

At step 304, the codebook used by the terminal is determined from the at least two sets of candidate codebooks based on the communication scenario where the terminal is located.

In the embodiment of the disclosure, the network device may determine, based on the communication scenario where the terminal is located, the codebook used by the terminal from the at least two sets of candidate codebooks.

In the embodiment of the disclosure, the network device supports the at least two sets of codebooks respectively applicable to different communication scenarios, and is capable of determining the codebook used by the terminal from the at least two sets of candidate codebooks.

The at least two sets of codebooks at least include the first codebook applicable to the far-field communication and the second codebook applicable to the near-field communication.

It should be noted that the far-field communication refers to communication under a condition that the terminal is in the far field, and the near-field communication refers to communication under a condition that the terminal is in the near field. It may be understood that a range in which the terminal is in the far-field condition and a range in which the terminal is in the near-field condition are related to an antenna aperture (antenna array size) of the network device and a communication frequency where the network device is located. For example, a larger antenna array size leads to a larger range of the near-field condition.

As an implementation, for example, the first codebook may be a codebook based on a two-dimensional DFT, and the second codebook may be a codebook based on a polar domain.

In an implementation, in a case that the terminal is in the far-field communication, the first codebook applicable to the far-field communication is determined as the codebook used by the terminal; and in a case that the terminal is in the near-field communication, the second codebook applicable to the near-field communication is determined as the codebook used by the terminal.

In some implementations, the method may further include step 305.

At step 305, first indication information is sent to the terminal, in which the first indication information indicates the codebook used by the terminal.

In the embodiment of the disclosure, after determining the codebook used by the terminal, the network device may send the first indication information to the terminal, in which the first indication information indicates the codebook used by the terminal.

In some implementations, the first indication information may directly indicate the codebook used by the terminal, may indicate switching the codebook used by the terminal. The codebook used by the terminal may be indicated using other indication manners, which is not limited in the embodiment of the disclosure. For example, in a case that the terminal is in the near-field communication, the first indication information may instruct the terminal to use the codebook applicable to the near-field communication, or may instruct the terminal to switch from the codebook applicable to the far-field communication to the codebook applicable to the near-field communication.

In the embodiment of the disclosure, the first indication information may be indicated by any one or more of: an RRC signaling; an MAC CE signaling; or DCI.

In an implementation, the first indication information may reuse an existing information field or bit, or may use a newly added information field or bit.

In summary, the first information is determined based on the antenna aperture of the network device and/or the communication frequency of the network device, in which the first information is used to distinguish the communication scenarios, and the communication scenarios include the far-field communication and the near-field communication; the information of the distance between the terminal and the network device is determined; the communication scenario where the terminal is located is determined based on the information of the distance and the first information; and the codebook used by the terminal is determined from the at least two sets of candidate codebooks based on the communication scenario where the terminal is located. This enables the network to flexibly select and switch the corresponding codebook based on the communication scenario where the terminal is located. In a case of switching between the far-field communication scenario and the near-field communication scenario that may exist in the high-frequency communication system, the channel capacity is effectively improved, the complexity of precoding is reduced, the balance between the complexity of precoding and maximization of channel capacity is achieved, and the reliability of information transmission of the entire communication system is ensured.

Referring to FIG. 4, it is a flow chart illustrating a method for communication based on precoding according to an embodiment of the disclosure. It needs to be noted that the method for communication based on precoding in the embodiment of the disclosure is performed by a network device. The method may be performed independently or may be performed in conjunction with any other embodiments of the disclosure. As shown in FIG. 4, the method may include the following steps 401 to 405.

At step 401, first information is determined based on an antenna aperture of the network device and/or a communication frequency of the network device, in which the first information is used by a terminal to determine a communication scenario where the terminal is located.

In the embodiment of the disclosure, the network device may determine the first information based on the antenna aperture of the network device and/or the communication frequency of the network device, in which the first information is used to distinguish the communication scenarios, and the communication scenarios include far-field communication and near-field communication.

It should be noted that the antenna aperture refers to an effective area size of an antenna for receiving or transmitting signals, usually measured in meters or square meters.

In an implementation, the first information may be switching threshold information or switching interval information for delimiting the communication scenario where the terminal is located.

As an example, the first information may be the switching threshold information. For example, the first information is a switching threshold x. The switching threshold x is a boundary for distinguishing whether the terminal is in the near-field communication or the far-field communication.

In an implementation, if a distance between the terminal and the network device is equal to the switching threshold x, the network device may determine the communication scenario of the terminal flexibly based on an actual situation.

As another example, the first information may be the switching interval information. For example, the first information is a switching interval [y, z]. The switching interval [y, z] is a boundary interval for distinguishing whether the terminal is in the near-field communication or the far-field communication.

In an implementation, if a distance between the terminal and the network device is within the switching interval [y, z], the network device may determine the communication scenario of the terminal flexibly based on an actual situation.

It may be understood that x, y, and z in the above examples are all distances, and y is less than z.

At step 402, the first information is sent to the terminal.

In the embodiment of the disclosure, after determining the first information, the network device may send the first information to the terminal, and the first information may be used by the terminal to determine the communication scenario where the terminal is located. That is, the terminal may determine whether the terminal is in the far-field communication or the near-field communication based on the received first information (and information of a distance between the terminal and the network device determined by the terminal), and further report auxiliary information to the network device.

At step 403, auxiliary information sent by the terminal is received.

In some implementations, the network device may receive the auxiliary information sent by the terminal and determine, based on the auxiliary information, the codebook used by the terminal from the at least two sets of candidate codebooks.

In an implementation, the auxiliary information includes: information of a distance between the terminal and the network device; or second indication information, in which the second indication information indicates a recommended codebook of the terminal for the communication scenario where the terminal is located.

In an implementation, the auxiliary information may also include information indicating the communication scenario where the terminal is located, or other information that may be used to assist the network device in selecting the codebook used by the terminal, etc., which is not limited in the embodiments of the disclosure.

In an implementation, the auxiliary information may be sent via a PUCCH or a PUSCH.

At step 404, the codebook used by the terminal is determined from the at least two sets of candidate codebooks based on the auxiliary information.

In the embodiment of the disclosure, the network device may determine, based on the auxiliary information reported by the terminal, the codebook used by the terminal from the at least two sets of candidate codebooks.

In the embodiment of the disclosure, the network device supports the at least two sets of codebooks respectively applicable to different communication scenarios, and is capable of determining the codebook used by the terminal from the at least two sets of candidate codebooks.

The at least two sets of codebooks at least include the first codebook applicable to the far-field communication and the second codebook applicable to the near-field communication.

It should be noted that the far-field communication refers to communication under a condition that the terminal is in the far field, and the near-field communication refers to communication under a condition that the terminal is in the near field. It may be understood that a range in which the terminal is in the far-field condition and a range in which the terminal is in the near-field condition are related to an antenna aperture (antenna array size) of the network device and a communication frequency where the network device is located. For example, a larger antenna array size leads to a larger range of the near-field condition.

As an implementation, for example, the first codebook may be a codebook based on a two-dimensional DFT, and the second codebook may be a codebook based on a polar domain.

As an implementation, the auxiliary information may include the information of the distance between the terminal and the network device. The network device may determine, based on the auxiliary information, the communication scenario where the terminal is located, and further determine, based on the communication scenario, the codebook used by the terminal.

In an implementation, in a case that the terminal is in the far-field communication, the first codebook applicable to the far-field communication is determined as the codebook used by the terminal; and in a case that the terminal is in the near-field communication, the second codebook applicable to the near-field communication is determined as the codebook used by the terminal.

As an implementation, the auxiliary information may include the second indication information, and the second indication information indicates the recommended codebook for the communication scenario where the terminal is located. The network device may determine, based on the auxiliary information, the codebook used by the terminal.

It may be understood that the auxiliary information sent by the terminal is to report the reference distance and/or the recommended codebook to the network device. The network device determines the codebook used by the terminal based on the auxiliary information reported by the terminal. The codebook used by the terminal finally determined by the network device may be the same as or different from the recommended codebook in the auxiliary information reported by the terminal.

As an implementation, the auxiliary information may include the information of the distance between the terminal and the network device, and the second indication information.

In an implementation, the auxiliary information may also include information indicating the communication scenario where the terminal is located, or other information that may be used to assist the network device in selecting the codebook used by the terminal, etc., which is not limited in the embodiments of the disclosure.

Further, it may be understood that, in the embodiments of the disclosure, the network device may determine the codebook used by the terminal based on the auxiliary information and other parameters in combination with the overall efficiency of the communication system.

In some implementations, the method may further include step 405.

At step 405, first indication information is sent to the terminal, in which the first indication information indicates the codebook used by the terminal.

In the embodiment of the disclosure, after determining the codebook used by the terminal, the network device may send the first indication information to the terminal, in which the first indication information indicates the codebook used by the terminal.

In some implementations, the first indication information may directly indicate the codebook used by the terminal, may indicate switching the codebook used by the terminal. The codebook used by the terminal may be indicated using other indication manners, which is not limited in the embodiments of the disclosure. For example, in a case that the terminal is in the near-field communication, the first indication information may instruct the terminal to use the codebook applicable to the near-field communication, or may instruct the terminal to switch from the codebook applicable to the far-field communication to the codebook applicable to the near-field communication.

In the embodiment of the disclosure, the first indication information may be indicated by any one or more of: an RRC signaling; an MAC CE signaling; or DCI.

In an implementation, the first indication information may reuse an existing information field or bit, or may use a newly added information field or bit.

In summary, the first information is determined based on the antenna aperture of the network device and/or the communication frequency of the network device, in which the first information is used by the terminal to determine the communication scenario where the terminal is located; the first information is sent to the terminal; the auxiliary information sent by the terminal is received; and the codebook used by the terminal is determined from the at least two sets of candidate codebooks based on the auxiliary information. This enables the network side to flexibly select and switch the corresponding codebook based on the communication scenario where the terminal is located. In a case of switching back and forth between the far-field communication scenario and the near-field communication scenario that may exist in the high-frequency communication system, the channel capacity is effectively improved, the complexity of precoding is reduced, the balance between the complexity of precoding and maximization of channel capacity is achieved, and the reliability of information transmission of the entire communication system is ensured.

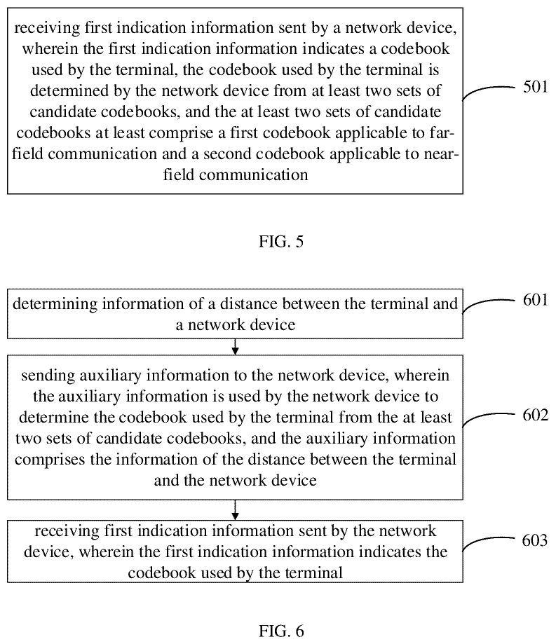

Referring to FIG. 5, it is a flow chart illustrating a method for communication based on precoding according to an embodiment of the disclosure. It needs to be noted that the method for communication based on precoding in the embodiment of the disclosure is performed by a terminal. The method may be performed independently or may be performed in conjunction with any other embodiments of the disclosure. As shown in FIG. 5, the method may include the following step 501.

At step 501, first indication information sent by a network device is received, in which the first indication information indicates a codebook used by the terminal, the codebook used by the terminal is determined by the network device from at least two sets of candidate codebooks, and the at least two sets of candidate codebooks at least include a first codebook applicable to far-field communication and a second codebook applicable to near-field communication.

In the embodiment of the disclosure, the terminal may receive the first indication information sent by the network device, and the first indication information indicates the codebook used by the terminal. The codebook used by the terminal is determined by the network device from the at least two sets of candidate codebooks, and the at least two sets of candidate codebooks at least include the first codebook applicable to the far-field communication and the second codebook applicable to the near-field communication. It may be understood that, in the embodiment of the disclosure, the network device supports the at least two sets of codebooks respectively applicable to different communication scenarios, and is capable of determining the codebook used by the terminal from the at least two sets of candidate codebooks.

It should be noted that the far-field communication refers to communication under a condition that the terminal is in the far field, and the near-field communication refers to communication under a condition that the terminal is in the near field. It may be understood that a range in which the terminal is in the far-field condition and a range in which the terminal is in the near-field condition are related to an antenna aperture (antenna array size) of the network device and a communication frequency where the network device is located. For example, a larger antenna array size leads to a larger range of the near-field condition.

As an implementation, for example, the first codebook may be a codebook based on a two-dimensional DFT, and the second codebook may be a codebook based on a polar domain.

In some implementations, the first indication information may directly indicate the codebook used by the terminal, may indicate switching the codebook used by the terminal. The codebook used by the terminal may be indicated using other indication manners, which is not limited in the embodiments of the disclosure. For example, in a case that the terminal is in the near-field communication, the first indication information may instruct the terminal to use the codebook applicable to the near-field communication, or may instruct the terminal to switch from the codebook applicable to the far-field communication to the codebook applicable to the near-field communication.

In the embodiment of the disclosure, the first indication information may be indicated by any one or more of: an RRC signaling; an MAC CE signaling; or DCI.

In an implementation, the first indication information may reuse an existing information field or bit, or may use a newly added information field or bit.

In some implementations, the codebook used by the terminal is determined by the network device from the at least two sets of candidate codebooks based on the communication scenario where the terminal is located.

In an implementation, in a case that the terminal is in the far-field communication, the first codebook applicable to the far-field communication is determined as the codebook used by the terminal; and in a case that the terminal is in the near-field communication, the second codebook applicable to the near-field communication is determined as the codebook used by the terminal.

In some implementations, the terminal may send auxiliary information to the network device, and the auxiliary information is used by the network device to determine the codebook used by the terminal from the at least two sets of candidate codebooks.

In an implementation, the auxiliary information includes: information of a distance between the terminal and the network device; or second indication information, in which the second indication information indicates a recommended codebook of the terminal for the communication scenario where the terminal is located.

In an implementation, the auxiliary information may also include information indicating the communication scenario where the terminal is located, or other information that may be used to assist the network device in selecting the codebook used by the terminal, etc., which is not limited in the embodiments of the disclosure.

In an implementation, the auxiliary information may be sent via a PUCCH or a PUSCH.

It may be understood that the auxiliary information sent by the terminal is to report a reference distance and/or a recommended codebook to the network device. The network device determines the codebook used by the terminal based on the auxiliary information reported by the terminal. The codebook used by the terminal that is finally determined by the network device may be the same as or different from the recommended codebook in the auxiliary information reported by the terminal.

In the embodiment of the disclosure, the terminal may determine the information of the distance between the terminal and the network device.

In an implementation, the terminal may determine, by calculating, the information of the distance between the terminal and the network device based on parameter information. The parameter information includes at least one of: a pathloss corresponding to the terminal; a TA corresponding to the terminal; or delay information corresponding to the terminal.

In some implementations, the terminal may also receive the first information sent by the network device, and may determine the communication scenario where the terminal is located based on the information of the distance between the terminal and the network device and the first information for distinguishing communication scenarios, and further determine the recommended codebook, for the communication scenario where the terminal is located, to be reported to the network device based on the communication scenario where the terminal is located.

The first information is determined by the network device based on an antenna aperture of the network device and/or a communication frequency where the network device is located. The first information may be used by the terminal to determine whether the terminal is in the communication scenario of the far-field communication or the near-field communication, and the terminal may also determine the auxiliary information based on the first information.

It should be noted that the antenna aperture refers to an effective area size of an antenna for receiving or transmitting signals, usually measured in meters or square meters.

In an implementation, the first information may be switching threshold information or switching interval information for delimiting the communication scenario where the terminal is located.

As an example, the first information may be the switching threshold information. For example, the first information is a switching threshold x. If a distance between the terminal and the network device is less than the switching threshold x, the terminal is considered to be located in the communication scenario of the near-field communication. If the distance between the terminal and the network device is greater than the switching threshold x, the terminal is considered to be located in the communication scenario of the far-field communication. If the distance between the terminal and the network device is equal to the switching threshold x, the terminal may be considered to be located in the communication scenario of the near-field communication, or may be considered to be located in the communication scenario of the far-field communication, which may be determined by the network device flexibly based on an actual situation.

As another example, the first information may be the switching interval information. For example, the first information is a switching interval [y, z]. If the distance between the terminal and the network device is less than a minimum value y of the switching interval, the terminal is delimited to be located in the communication scenario of the near-field communication. If the distance between the terminal and the network device is greater than a maximum value z of the switching interval, the terminal is delimited to be located in the communication scenario of the far-field communication. If the distance between the terminal and the network device is within the switching interval [y, z], the terminal may be delimited to be located in the communication scenario of the near-field communication, or may be delimited to be located in the communication scenario of the far-field communication, which may be determined by the network device flexibly based on an actual situation.

It may be understood that x, y, and z in the above examples are all distances, and y is less than z.

In summary, the first indication information sent by the network device is received, in which the first indication information indicates the codebook used by the terminal, the codebook used by the terminal is determined by the network device from the at least two sets of candidate codebooks, and the at least two sets of candidate codebooks at least include the first codebook applicable to the far-field communication and the second codebook applicable to the near-field communication. This enables the network to flexibly select and switch the corresponding codebook based on the communication scenario where the terminal is located. In a case of switching between the far-field communication scenario and the near-field communication scenario that may exist in the high-frequency communication system, the channel capacity is effectively improved, the complexity of precoding is reduced, the balance between the complexity of precoding and maximization of channel capacity is achieved, and the reliability of information transmission of the entire communication system is ensured.

Referring to FIG. 6, it is a flow chart illustrating a method for communication based on precoding according to an embodiment of the disclosure. It needs to be noted that the method for communication based on precoding in the embodiment of the disclosure is performed by a terminal. The method may be performed independently or may be performed in conjunction with any other embodiments of the disclosure. As shown in FIG. 6, the method may include the following steps 601 to 603.

At step 601, information of a distance between the terminal and a network device is determined.

In the embodiment of the disclosure, the terminal may determine the information of the distance between the terminal and the network device.

In an implementation, the terminal may determine, by calculating, the information of the distance between the terminal and the network device based on parameter information. The parameter information includes at least one of: a pathloss corresponding to the terminal; a TA corresponding to the terminal; or delay information corresponding to the terminal.

At step 602, auxiliary information is sent to the network device, in which the auxiliary information is used by the network device to determine the codebook used by the terminal from the at least two sets of candidate codebooks, and the auxiliary information includes the information of the distance between the terminal and the network device.

In the embodiment of the disclosure, the terminal may send the auxiliary information to the network device. The auxiliary information includes the information of the distance determined by the terminal, and the auxiliary information is used by the network device to determine the codebook used by the terminal from the at least two sets of candidate codebooks. The network device may determine the communication scenario where the terminal is located based on the information of the distance reported by the terminal, and further determine the codebook used by the terminal from the at least two sets of candidate codebooks. The at least two sets of candidate codebooks at least include the first codebook applicable to the far-field communication and the second codebook applicable to the near-field communication. It may be understood that, in the embodiment of the disclosure, the network device supports the at least two sets of codebooks respectively applicable to different communication scenarios, and is capable of determining the codebook used by the terminal from the at least two sets of candidate codebooks.

It should be noted that the far-field communication refers to communication under a condition that the terminal is in the far field, and the near-field communication refers to communication under a condition that the terminal is in the near field. It may be understood that a range in which the terminal is in the far-field condition and a range in which the terminal is in the near-field condition are related to an antenna aperture (antenna array size) of the network device and a communication frequency of the network device. For example, a larger antenna array size leads to a larger range of the near-field condition.

As an implementation, for example, the first codebook may be a codebook based on a two-dimensional DFT, and the second codebook may be a codebook based on a polar domain.

In an implementation, the auxiliary information may also include information indicating the communication scenario where the terminal is located, or other information that may be used to assist the network device in selecting the codebook used by the terminal, etc., which is not limited in the embodiments of the disclosure.

In an implementation, the auxiliary information may be sent via a PUCCH or a PUSCH.

At step 603, first indication information sent by the network device is received, in which the first indication information indicates a codebook used by the terminal.

In the embodiment of the disclosure, the terminal may receive the first indication information sent by the network device, and the first indication information indicates the codebook used by the terminal. The codebook used by the terminal is determined by the network device from the at least two sets of candidate codebooks.

In some implementations, the first indication information may directly indicate the codebook used by the terminal, may indicate switching the codebook used by the terminal. The codebook used by the terminal may be indicated using other indication methods, which is not limited in the embodiments of the disclosure. For example, in a case that the terminal is in the near-field communication, the first indication information may instruct the terminal to use the codebook applicable to the near-field communication, or may instruct the terminal to switch from the codebook applicable to the far-field communication to the codebook applicable to the near-field communication.

In the embodiment of the disclosure, the first indication information may be indicated by any one or more of: an RRC signaling; an MAC CE signaling; or DCI.

In an implementation, the first indication information may reuse an existing information field or bit, or may use a newly added information field or bit.

In summary, the information of the distance between the terminal and the network device is determined; the auxiliary information is sent to the network device, in which the auxiliary information is used by the network device to determine the codebook used by the terminal from the at least two sets of candidate codebooks, and the auxiliary information includes the information of the distance between the terminal and the network device; and the first indication information sent by the network device is received, in which the first indication information indicates the codebook used by the terminal. This enables the network side to flexibly select and switch the corresponding codebook based on the communication scenario where the terminal is located. In a case of switching between the far-field communication scenario and the near-field communication scenario that may exist in the high-frequency communication system, the channel capacity is effectively improved, the complexity of precoding is reduced, the balance between the complexity of precoding and maximization of channel capacity is achieved, and the reliability of information transmission of the entire communication system is ensured.

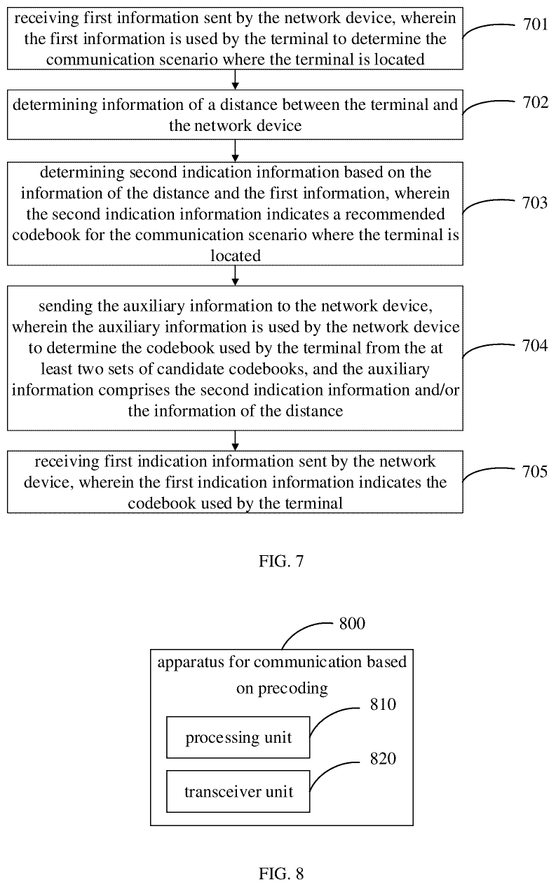

Referring to FIG. 7, it is a flow chart illustrating a method for communication based on precoding according to an embodiment of the disclosure. It needs to be noted that the method for communication based on precoding in the embodiment of the disclosure is performed by a terminal. The method may be performed independently or may be performed in conjunction with any other embodiments of the disclosure. As shown in FIG. 7, the method may include the following steps 701 to 705.

At step 701, first information sent by a network device is received, in which the first information is used by the terminal to determine a communication scenario where the terminal is located.

In the embodiment of the disclosure, the terminal may receive the first indication information sent by the network device, and the first indication information indicates the codebook used by the terminal.

The first information is determined by the network device based on an antenna aperture of the network device and/or a communication frequency of the network device. The first information may be used by the terminal to determine whether the terminal is in a communication scenario of the far-field communication or the near-field communication, and the terminal may also determine auxiliary information reported to the network device based on the first information.

It should be noted that the antenna aperture refers to an effective area size of an antenna for receiving or transmitting signals, usually measured in meters or square meters.

In an implementation, the first information may be switching threshold information or switching interval information for delimiting the communication scenario where the terminal is located.

As an example, the first information may be the switching threshold information. For example, the first information is a switching threshold x. If a distance between the terminal and the network device is less than the switching threshold x, the terminal is considered to be located in the communication scenario of the near-field communication. If the distance between the terminal and the network device is greater than the switching threshold x, the terminal is considered to be located in the communication scenario of the far-field communication. If the distance between the terminal and the network device is equal to the switching threshold x, the terminal may be considered to be located in the communication scenario of the near-field communication, or may be considered to be located in the communication scenario of the far-field communication, which may be determined by the network device flexibly based on an actual situation.

As another example, the first information may be the switching interval information. For example, the first information is a switching interval [y, z]. If the distance between the terminal and the network device is less than a minimum value y of the switching interval, the terminal is delimited to be located in the communication scenario of the near-field communication. If the distance between the terminal and the network device is greater than a maximum value z of the switching interval, the terminal is delimited to be located in the communication scenario of the far-field communication. If the distance between the terminal and the network device is within the switching interval [y, z], the terminal may be delimited to be located in the communication scenario of the near-field communication, or may be delimited to be locate in the communication scenario of the far-field communication, which may be determined by the network device flexibly based on an actual situation.

It may be understood that x, y, and z in the above examples are all distances, and y is less than z.

At step 702, information of a distance between the terminal and the network device is determined.

In the embodiment of the disclosure, the terminal may determine the information of the distance between the terminal and the network device.

In an implementation, the terminal may determine, by calculating, the information of the distance between the terminal and the network device based on parameter information. The parameter information includes at least one of: a pathloss corresponding to the terminal; a TA corresponding to the terminal; or delay information corresponding to the terminal.

At step 703, second indication information is determined based on the information of the distance and the first information, in which the second indication information indicates a recommended codebook for a communication scenario where the terminal is located.

In the embodiment of the disclosure, the terminal may determine the communication scenario where the terminal is located based on the information of the distance between the terminal and the network device and the received first information, and further determine the recommended codebook, for the communication scenario where the terminal is located, to be reported to the network device based on the communication scenario where the terminal is located.

As an example, the first information may be the switching threshold information. For example, the first information is a switching threshold x (e.g., x may be 25 meters). If a distance between the terminal and the network device is less than the switching threshold x, the terminal is considered to be located in the communication scenario of the near-field communication. If the distance between the terminal and the network device is greater than the switching threshold x, the terminal is considered to be located in the communication scenario of the far-field communication. If the distance between the terminal and the network device is equal to the switching threshold x, the terminal may be considered to be located in the communication scenario of the near-field communication, or may be considered to be located in the communication scenario of the far-field communication, which may be determined by the network device flexibly based on an actual situation.

As another example, the first information may be the switching interval information. For example, the first information is a switching interval [y, z] (e.g., y-z may be [20, 25] meters). If the distance between the terminal and the network device is less than the minimum value y of the switching interval, the terminal is delimited to be located in the communication scenario of the near-field communication. If the distance between the terminal and the network device is greater than the maximum value z of the switching interval, the terminal is delimited to be located in the communication scenario of the far-field communication. If the distance between the terminal and the network device is within the switching interval [y, z], the terminal may be delimited to be located in the communication scenario of the near-field communication, or may be delimited to be located in the communication scenario of the far-field communication, which may be determined flexibly based on an actual situation.

It may be understood that x, y, and z in the above examples are all distances, and y is less than z.

In an implementation, in a case that the terminal is in the far-field communication, the first codebook applicable to the far-field communication is determined as the codebook used by the terminal; and in a case that the terminal is in the near-field communication, the second codebook applicable to the near-field communication is determined as the codebook used by the terminal.

At step 704, the auxiliary information is sent to the network device, in which the auxiliary information is used by the network device to determine the codebook used by the terminal from the at least two sets of candidate codebooks, and the auxiliary information includes the second indication information and/or the information of the distance.

In the embodiment of the disclosure, the terminal may send the auxiliary information to the network device. The auxiliary information is used by the network device to determine the codebook used by the terminal from the at least two sets of candidate codebooks. The network device may determine the communication scenario where the terminal is located based on the information of the distance reported by the terminal, and further determine the codebook used by the terminal from the at least two sets of candidate codebooks. The at least two sets of candidate codebooks at least include the first codebook applicable to the far-field communication and the second codebook applicable to the near-field communication. It may be understood that, in the embodiment of the disclosure, the network device supports the at least two sets of codebooks respectively applicable to different communication scenarios, and is capable of determining the codebook used by the terminal from the at least two sets of candidate codebooks.

It should be noted that the far-field communication refers to communication under a condition that the terminal is in the far field, and the near-field communication refers to communication under a condition that the terminal is in the near field. It may be understood that a range in which the terminal is in the far-field condition and a range in which the terminal is in the near-field condition are related to an antenna aperture (antenna array size) of the network device and a communication frequency of the network device. For example, a larger antenna array size leads to a larger range of the near-field condition.

As an implementation, for example, the first codebook may be a codebook based on a two-dimensional DFT, and the second codebook may be a codebook based on a polar domain.

In an implementation, the auxiliary information may include the second indication information and/or the information of the distance.

In an implementation, the auxiliary information may also include information indicating the communication scenario where the terminal is located, or other information that may be used to assist the network device in selecting the codebook used by the terminal, etc., which is not limited in the embodiments of the disclosure.

In an implementation, the auxiliary information may be sent via a PUCCH or a PUSCH.

It may be understood that the auxiliary information sent by the terminal is to report a reference distance and/or a recommended codebook to the network device. The network device determines the codebook used by the terminal based on the auxiliary information reported by the terminal. The codebook used by the terminal finally determined by the network device may be the same as or different from the recommended codebook in the auxiliary information reported by the terminal.

At step 705, first indication information sent by the network device is received, in which the first indication information indicates the codebook used by the terminal.

In the embodiment of the disclosure, the terminal may receive the first indication information sent by the network device, and the first indication information indicates the codebook used by the terminal. The codebook used by the terminal is determined by the network device from the at least two sets of candidate codebooks.

In some implementations, the first indication information may directly indicate the codebook used by the terminal, or may indicate switching the codebook used by the terminal. The codebook used by the terminal may be indicated using other indication manners, which is not limited in the embodiment of the disclosure. For example, in a case that the terminal is in the near-field communication, the first indication information may instruct the terminal to use the codebook applicable to the near-field communication, or may instruct the terminal to switch from the codebook applicable to the far-field communication to the codebook applicable to the near-field communication.

In the embodiment of the disclosure, the first indication information may be indicated by any one or more of: an RRC signaling; an MAC CE signaling; or DCI.

In an implementation, the first indication information may reuse an existing information field or bit, or may use a newly added information field or bit.

In summary, the first information sent by the network device is received, in which the first information is used by the terminal to determine the communication scenario where the terminal is located; the information of the distance between the terminal and the network device is determined; the second indication information is determined based on the information of the distance and the first information, in which the second indication information indicates the recommended codebook for the communication scenario where the terminal is located; the auxiliary information is sent to the network device, in which the auxiliary information is used by the network device to determine the codebook used by the terminal from the at least two sets of candidate codebooks, and the auxiliary information includes the second indication information and the information of the distance; and the first indication information sent by the network device is received, in which the first indication information indicates the codebook used by the terminal. This enables the network to flexibly select and switch the corresponding codebook based on the communication scenario where the terminal is located. In a case of switching between the far-field communication scenario and the near-field communication scenario that may exist in the high-frequency communication system, the channel capacity is effectively improved, complexity of precoding is reduced, the balance between the complexity of precoding and maximization of channel capacity is achieved, and the reliability of information transmission of the entire communication system is ensured.

Corresponding to the methods for communication based on precoding provided in the foregoing embodiments, the disclosure further provides an apparatus for communication based on precoding. Since the apparatus for communication based on precoding provided in the embodiments of the disclosure corresponds to the method for communication based on precoding provided in the foregoing embodiments, the implementations of the methods for communication based on precoding are also applicable to the apparatus for communication based on precoding provided in the following embodiments, which is not described in detail here.

Referring to FIG. 8, it is a block diagram illustrating an apparatus for communication based on precoding according to an embodiment of the disclosure.

As shown in FIG. 8, the apparatus 800 for communication based on precoding includes a processing unit 810 and a transceiver unit 820.

The processing unit 810 is configured to determine a codebook used by a terminal from at least two sets of candidate codebooks, in which the at least two sets of candidate codebooks at least include a first codebook applicable to far-field communication and a second codebook applicable to near-field communication.

The transceiver unit 820 is configured to send first indication information to the terminal, in which the first indication information indicates the codebook used by the terminal.

In an implementation, the processing unit 810 is specifically configured to determine, based on a communication scenario where the terminal is located, the codebook used by the terminal from the at least two sets of candidate codebooks.

In an implementation, the processing unit 810 is specifically configured to determine, based on a communication scenario where the terminal is located, the codebook used by the terminal from the at least two sets of candidate codebooks.

In an implementation, the processing unit 810 is further configured to determine first information based on an antenna aperture of the network device and/or a communication frequency where the network device is located, in which the first information is used to distinguish communication scenarios, and the communication scenarios include the far-field communication and the near-field communication; determine information of a distance between the terminal and the network device; and determine the communication scenario where the terminal is located based on the information of the distance and the first information.

In an implementation, the processing unit 810 is specifically configured to determine the information of the distance between the terminal and the network device based on a sensing signal sent by the network device; and/or determine the information of the distance between the terminal and the network device based on parameter information, the parameter information including at least one of: a pathloss corresponding to the terminal; a TA corresponding to the terminal; or delay information corresponding to the terminal.

In an implementation, the processing unit 810 is specifically configured to receive auxiliary information sent by the terminal; and determine, based on the auxiliary information, the codebook used by the terminal from the at least two sets of candidate codebooks.

In an implementation, the auxiliary information includes at least one of: information of a distance between the terminal and the network device; or second indication information, in which the second indication information indicates a recommended codebook of the terminal for a communication scenario where the terminal is located.

In an implementation, the processing unit 810 is further configured to determine first information based on an antenna aperture of the network device and/or a communication frequency where the network device is located, in which the first information is used by the terminal to determine the communication scenario where the terminal is located; and send the first information to the terminal.

In an implementation, the first information is switching threshold information or switching interval information for delimiting the communication scenario where the terminal is located.

In an implementation, the first indication information is included in at least one of: an RRC signaling; an MAC CE signaling; or DCI.

In the apparatus for communication based on precoding provided in embodiments of the disclosure, the codebook used by the terminal is determined from the at least two sets of candidate codebooks, in which the at least two sets of candidate codebooks at least include the first codebook applicable to the far-field communication and the second codebook applicable to the near-field communication; and the first indication information is sent to the terminal, in which the first indication information indicates the codebook used by the terminal. This enables the network side to flexibly select and switch the corresponding codebook based on the communication scenario where the terminal is located. In a case of switching between the far-field communication scenario and the near-field communication scenario that may exist in the high-frequency communication system, the channel capacity is effectively improved, the complexity of precoding is reduced, the balance between the complexity of precoding and maximization of channel capacity is achieved, and the reliability of information transmission of the entire communication system is ensured.

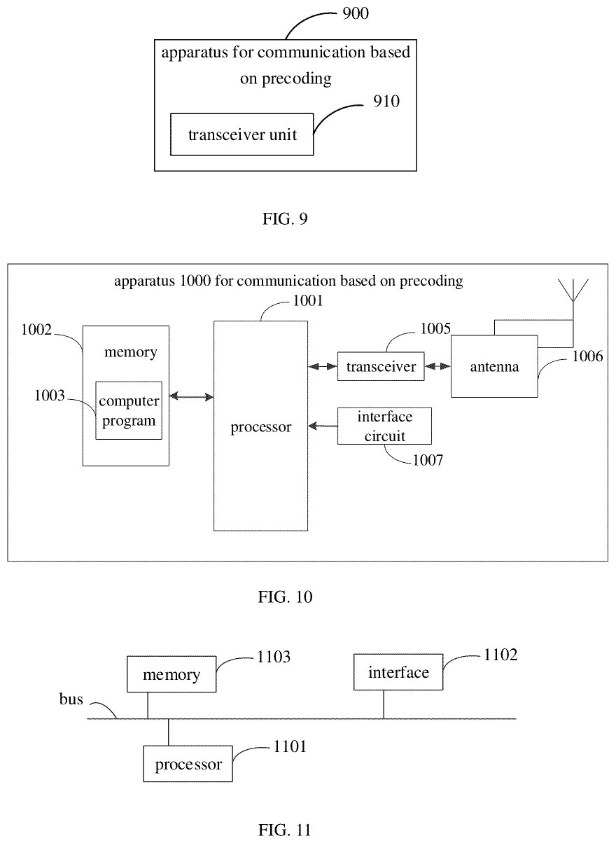

Referring to FIG. 9, it is a block diagram illustrating an apparatus for communication based on precoding according to an embodiment of the disclosure.

As shown in FIG. 9, the apparatus 900 for communication based on precoding includes a transceiver unit 910.

The transceiver unit 910 is configured to receive first indication information sent by a network device, in which the first indication information indicates a codebook used by the terminal, the codebook used by the terminal is determined by the network device from at least two sets of candidate codebooks, and the at least two sets of candidate codebooks at least include a first codebook applicable to far-field communication and a second codebook applicable to near-field communication.

In an implementation, the transceiver unit 910 is further configured to send auxiliary information to the network device, in which the auxiliary information is used by the network device to determine the codebook used by the terminal from the at least two sets of candidate codebooks.

In an implementation, the auxiliary information includes at least one of: information of a distance between the terminal and the network device; or second indication information, in which the second indication information indicates a recommended codebook of the terminal for a communication scenario where the terminal is located.

In an implementation, the apparatus further includes a processing unit (not illustrated in the figure) configured to determine the information of the distance between the terminal and the network device.

In an implementation, the processing unit is specifically configured to determine the information of the distance between the terminal and the network device based on parameter information, the parameter information including at least one of: a pathloss corresponding to the terminal; a TA corresponding to the terminal; or delay information corresponding to the terminal.

In an implementation, the transceiver unit 910 is further configured to receive first information sent by the network device, in which the first information is used by the terminal to determine the communication scenario where the terminal is located, and the first information is determined by the network device based on an antenna aperture of the network device and/or a communication frequency where the network device is located; and determine the second indication information based on the information of the distance and the first information.

In an implementation, the first information is switching threshold information or switching interval information for delimiting the communication scenario where the terminal is located.

In an implementation, the first indication information is included in at least one of: an RRC signaling; an MAC CE signaling; or DCI.

In the apparatus for communication based on precoding provided in embodiments of the disclosure, the first indication information sent by the network device is received, in which the first indication information indicates the codebook used by the terminal, the codebook used by the terminal is determined by the network device from the at least two sets of candidate codebooks, and the at least two sets of candidate codebooks at least include the first codebook applicable to the far-field communication and the second codebook applicable to the near-field communication. This enables the network to flexibly select and switch the corresponding codebook based on the communication scenario where the terminal is located. In a case of switching between the far-field communication scenario and the near-field communication scenario that may exist in the high-frequency communication system, the channel capacity is effectively improved, the complexity of precoding is reduced, the balance between the complexity of precoding and maximization of channel capacity is achieved, and the reliability of information transmission of the entire communication system is ensured.

To implement the above embodiments, the embodiments of the disclosure further provide a communication apparatus. The communication apparatus includes a processor and a memory storing a computer program. When the computer program is executed by the processor, the communication apparatus is caused to implement any method shown in the embodiments in FIG. 2 to FIG. 4.

To implement the above embodiments, the embodiments of the disclosure further provide a communication apparatus. The communication apparatus includes a processor and a memory storing a computer program. When the computer program is executed by the processor, the communication apparatus is caused to implement any method shown in embodiments in FIG. 5 to FIG. 7.

To implement the above embodiments, the embodiments of the disclosure further provide a communication apparatus. The communication apparatus includes a processor and an interface circuit. The interface circuit is configured to receive code instructions and transmit the code instructions to the processor; and the processor is configured to execute the code instructions to implement any method shown in the embodiments in FIG. 2 to FIG. 4.

To implement the above embodiments, the embodiments of the disclosure further provide a communication apparatus. The communication apparatus includes a processor and an interface circuit. The interface circuit is configured to receive code instructions and transmit the code instructions to the processor; and the processor is configured to execute the code instructions to implement any method shown in the embodiments in FIG. 5 to FIG. 7.

Referring to FIG. 10, it is a block diagram illustrating an apparatus for communication based on precoding according to an embodiment of the disclosure. The apparatus 1000 for communication based on precoding may be a network device, a terminal, a chip, a system on chip or a processor that supports the network device to implement the above methods, or a chip, a system on chip or a processor that supports the terminal to implement the above methods. The apparatus 1000 for communication based on precoding may be configured to implement the methods described in the method embodiments, which may refer to descriptions in the method embodiments.

The apparatus 1000 for communication based on precoding may include one or more processors 1001. The processor 1001 may include a general purpose processor or a dedicated processor. For example, the processor may be a baseband processor or a central processor. The baseband processor may be configured to process a communication protocol and communication data, and the central processor may be configured to control a communication apparatus (e.g., a base station, a baseband chip, a terminal, a terminal chip, a DU or CU, etc.), to execute a computer program, and process data of the computer program.

In an implementation, the apparatus 1000 for communication based on precoding may further include one or more memories 1002 with a computer program 1003 stored. The computer program 1003 is executed so that the apparatus 1000 for communication based on precoding performs any method as described in the above method embodiments. The computer program 1003 may be solidified in the processor 1001, in which case the processor 1001 may be implemented by hardware.

In an implementation, the memory 1002 may further store data. The apparatus 1000 for communication based on precoding and the memory 1002 may be independently configured or integrated together.

In an implementation, the apparatus 1000 for communication based on precoding may further include a transceiver 1005 and an antenna 1006. The transceiver 1005 may be referred to as a transceiving unit, a transceiver or a transceiving circuit, which may be configured to achieve a transceiving function. The transceiver 1005 may include a receiver and a transmitter. The receiver may be referred to as a receiving machine or a receiving circuit, etc., for implementing a receiving function; the transmitter may be referred to as a transmitting machine or a transmitting circuit, etc. for implementing a transmitting function.

In an implementation, the apparatus 1000 for communication based on precoding may further include one or more interface circuits 1007. The interface circuit 1007 is configured to receive code instructions and transmit the code instructions to the processor 1001. The code instructions are executed by the processor 1001 so that the communication apparatus 1000 performs any method as described in the above method embodiments.

In an implementation, the processor 1001 may include a transceiver configured to implement receiving and transmitting functions. For example, the transceiver may be a transceiving circuit, or an interface, or an interface circuit. The transceiving circuit, the interface or the interface circuit configured to implement receiving and transmitting functions may be separate or integrated together. The transceiving circuit, the interface or the interface circuit may be configured to read and write codes/data, or the transceiving circuit, the interface or the interface circuit may be configured to transmit or deliver a signal.

In an implementation, the apparatus 1000 for communication based on precoding may include a circuit that may implement a transmitting or receiving or communication function in the above method embodiments. The processor and the transceiver described in the disclosure may be implemented on integrated circuits (ICs), analog ICs, radio frequency integrated circuits (RFICs), mixed signal ICs, application specific integrated circuits (ASICs), printed circuit boards (PCBs), electronic devices, etc. The processor and the transceiver may further be fabricated by using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe) and gallium arsenide (GaAs).

The apparatus for communication based on precoding described in the above embodiments may be a network device or a terminal, but the scope of the apparatus for communication based on precoding described in the disclosure is not limited thereto, and a structure of the apparatus for communication based on precoding may not be limited by FIG. 8 to FIG. 9. The apparatus for communication based on precoding may be a stand-alone device or may be a part of a larger device. For example, the apparatus for communication based on precoding may be:
(1) a stand-alone integrated circuit (IC), or a chip, or a system on chip or a subsystem;
(2) a set of one or more ICs, which may also include a storage component for storing data and a computer program;
(3) an ASIC, such as a Modem;
(4) a module that may be embedded within other devices;
(5) a receiver, a terminal, a smart terminal device, a cellular phone, a wireless device, a handset, a mobile unit, a vehicle-mounted device, a network side device, a cloud device, an artificial intelligence device, etc.;
(6) others, and so forth.

In the case that the apparatus for communication based on precoding may be a chip or a system on chip, reference can be made to a block diagram of a chip shown in FIG. 11. The chip shown in FIG. 11 includes a processor 1101 and an interface 1102. There may be one or more processors 1101 and there may be a plurality of interfaces 1102.

In a case that the chip is configured to implement functions of the first network device in the embodiments of the disclosure, the interface 1102 is configured to receive code instructions and transmit the code instructions to the processor; and the processor 1101 is configured to execute the code instructions to implement any method in FIG. 2 to FIG. 4.

In a case that the chip is configured to implement functions of the third network device in the embodiments of the disclosure, the interface 1102 is configured to receive code instructions and transmit the code instructions to the processor; and the processor 1101 is configured to execute the code instructions to implement any method in FIG. 5 to FIG. 7.

In an implementation, the chip further includes a memory 1103, configured to save necessary computer program and data.

Those skilled in the related art may understand that, various illustrative logical blocks and steps listed in embodiments of the disclosure, may be implemented by electronic hardware, computer software or a combination of the electronic hardware and the computer software. Whether the function is implemented by the hardware or the software depends on specific applications and design requirements for an overall system. Those skilled in the art may implement the functions by using various methods for each specific application, but such an implementation should not be understood as beyond the protection scope of embodiments of the disclosure.

An embodiment of the disclosure further provides a communication system. The system includes the apparatus for communication based on precoding functioning as the network device, and the apparatus for communication based on precoding functioning as the terminal in the aforementioned embodiments of FIG. 8 to FIG. 9, or the system includes the apparatus for communication based on precoding functioning as the terminal, and the apparatus for communication based on precoding functioning as the network device in the aforementioned embodiment of FIG. 10.

The disclosure further provides a readable storage medium with instructions stored. When the instructions are executed by a computer, steps in the any method embodiment are implemented.

A computer program product is further provided in the disclosure. The computer program product implements functions of the above any method embodiment when executed by a processor.

In the above embodiments, the functions may be wholly or partially implemented by software, hardware, firmware, or any combination of them. When implemented by software, the functions may be implemented in whole or in part in the form of a computer program product. The computer program product includes one or more computer programs. Procedures or functions according to embodiments of the disclosure are wholly or partially generated when the computer program is loaded and executed on a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another via wire (such as a coaxial cable, a fiber optic, a digital subscriber line (DSL)) or wireless (such as infrared, wireless, microwave). The computer-readable storage medium may be any available medium that may be accessed by a computer or a data storage device such as a server that integrates one or more of the available media, and a data center. The readable medium may be a magnetic medium (such as a floppy disk, a hard disk and a magnetic tape), an optical medium (such as a digital video disk (DVD)), or a semiconductor medium (such as a solid state disk (SSD)).

Those skilled in the art may understand that various numbers such as first and second involved in the disclosure are distinguished merely for convenience of description, and are not intended to limit the scope of the embodiments of the disclosure, but also to indicate an order of precedence.

The phase “at least one” in the disclosure may also be described as one or more, and the phase “a plurality of” may refer to two, three, four or more, which is not limited in the disclosure. In the embodiments of the disclosure, for a kind of technical feature, technical features in the kind of technical feature are distinguished by “first”, “second”, “third”, “A”, “B”, “C” and “D”, and there is no order of precedence or magnitude between the technical features described in “first”, “second”, “third”, “A”, “B”, “C” and “D”.

Corresponding relationships indicated by tables in the disclosure may be configured or predefined. A value of information in the tables is only an example, and may be configured as other values, which is not limited in the disclosure. When corresponding relationships between information and parameters are configured, it is not always necessary to configure all corresponding relationships indicated in the tables. For example, in the tables in the disclosure, the corresponding relationships indicated by some rows may not be configured. For another example, appropriate transformations and adjustments, such as splitting and merging, may be made based on the above tables. Names of parameters shown in headers in the tables may be other names understandable by the communication apparatus, and values or representations of the parameters may be other values or representations understandable by the communication apparatus. When the above tables are implemented, other data structures may be used, and for example, arrays, queues, containers, stacks, linear lists, pointers, linked lists, trees, graphs, structures, classes, heaps or hash tables may be used.

Predefined in the disclosure may be understood as defined, predefined, stored, pre-stored, pre-negotiated, pre-configured, solidified or pre-fired.

Those skilled in the related art may realize that, in combination with units and algorithm steps of the examples described in embodiments of the disclosure, may be implemented by electronic hardware or a combination of electronic hardware and computer software. Whether the functions are executed by the hardware or the software depends on a specific application and a design constraint of the technical solution. Those skilled in the art may adopt different methods for each specific application to implement the described functions, but such implementation should not be considered as going beyond the scope of the disclosure.

Those skilled in the art may clearly understand that, a specific working process of a system, an apparatus and a unit described above may refer to a corresponding process in the above method embodiments, which will not be repeated here.

It should be understood that the various forms of processes shown above can be used to reorder, add or delete steps. For example, the steps described in embodiments of the disclosure may be performed in parallel, sequentially, or in a different order, as long as the desired result of the technical solution disclosed in the invention is achieved, which is not limited in the disclosure.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

1. A method for communication based on precoding, performed by a network device, comprising:
determining a codebook used by a terminal from at least two sets of candidate codebooks, wherein the at least two sets of candidate codebooks comprise a first codebook applicable to far-field communication and a second codebook applicable to near-field communication; and
sending first indication information to the terminal, wherein the first indication information indicates the codebook used by the terminal.

2. The method according to claim 1, wherein determining the codebook used by the terminal from the at least two sets of candidate codebooks comprises:
determining, based on a communication scenario where the terminal is located, the codebook used by the terminal from the at least two sets of candidate codebooks.

3. The method according to claim 2, wherein determining, based on the communication scenario where the terminal is located, the codebook used by the terminal from the at least two sets of candidate codebooks comprises:
in a case that the terminal is in the far-field communication, determining that the codebook used by the terminal is the first codebook applicable to the far-field communication; and
in a case that the terminal is in the near-field communication, determining that the codebook used by the terminal is the second codebook applicable to the near-field communication.

4. The method according to claim 2, further comprising:
determining first information based on at least one of an antenna aperture of the network device or a communication frequency where the network device is located, wherein the first information is used to distinguish communication scenarios, and the communication scenarios comprise the far-field communication and the near-field communication;
determining information of a distance between the terminal and the network device; and
determining the communication scenario where the terminal is located based on the information of the distance and the first information.

5. The method according to claim 4, wherein determining the information of the distance between the terminal and the network device comprises at least one of:
determining the information of the distance between the terminal and the network device based on a sensing signal sent by the network device; or
determining the information of the distance between the terminal and the network device based on parameter information, the parameter information comprising at least one of:
a pathloss corresponding to the terminal;
a timing advance (TA) corresponding to the terminal; or
delay information corresponding to the terminal.

6. The method according to claim 1, wherein determining the codebook used by the terminal from the at least two sets of candidate codebooks comprises:
receiving auxiliary information sent by the terminal; and
determining, based on the auxiliary information, the codebook used by the terminal from the at least two sets of candidate codebooks.

7. The method according to claim 6, wherein the auxiliary information comprises at least one of:
information of a distance between the terminal and the network device; or
second indication information, wherein the second indication information indicates a recommended codebook of the terminal for a communication scenario where the terminal is located.

8. The method according to claim 6, further comprising:
determining first information based on at least one of an antenna aperture of the network device or a communication frequency where the network device is located, wherein the first information is used by the terminal to determine a communication scenario where the terminal is located; and
sending the first information to the terminal.

9. The method according to claim 4, wherein the first information is switching threshold information or switching interval information for delimiting the communication scenario where the terminal is located.

10. The method according to claim 1, wherein the first indication information is comprised in at least one of:
a radio resource control (RRC) signaling;
a media access control (MAC) control element (CE) signaling; or
downlink control information (DCI).

11. A method for communication based on precoding, performed by a terminal, comprising:
receiving first indication information sent by a network device, wherein the first indication information indicates a codebook used by the terminal, the codebook used by the terminal is determined by the network device from at least two sets of candidate codebooks, and the at least two sets of candidate codebooks comprise a first codebook applicable to far-field communication and a second codebook applicable to near-field communication.

12. The method according to claim 11, further comprising:
sending auxiliary information to the network device, wherein the auxiliary information is used by the network device to determine the codebook used by the terminal from the at least two sets of candidate codebooks.

13. The method according to claim 12, wherein the auxiliary information comprises at least one of:
information of a distance between the terminal and the network device; or
second indication information, wherein the second indication information indicates a recommended codebook of the terminal for a communication scenario where the terminal is located.

14. The method according to claim 13, further comprising:
determining the information of the distance between the terminal and the network device.

15. The method according to claim 14, wherein determining the information of the distance between the terminal and the network device comprises:
determining the information of the distance between the terminal and the network device based on parameter information, the parameter information comprising at least one of:
a pathloss corresponding to the terminal;
a timing advance (TA) corresponding to the terminal; or
delay information corresponding to the terminal.

16. The method according to claim 13, further comprising:
receiving first information sent by the network device, wherein the first information is used by the terminal to determine the communication scenario where the terminal is located, and the first information is determined by the network device based on at least one of an antenna aperture of the network device or a communication frequency where the network device is located; and
determining the second indication information based on the information of the distance and the first information.

17. The method according to claim 16, wherein the first information is switching threshold information or switching interval information for delimiting the communication scenario where the terminal is located.

18. The method according to claim 11, wherein the first indication information is comprised in at least one of:
a radio resource control (RRC) signaling;
a media access control (MAC) control element (CE) signaling; or
downlink control information (DCI).

19-20. (canceled)

21. A network device, comprising:
a processor; and
a memory storing a computer program executable by the processor,
wherein the processor is configured to:
determine a codebook used by a terminal from at least two sets of candidate codebooks, wherein the at least two sets of candidate codebooks comprise a first codebook applicable to far-field communication and a second codebook applicable to near-field communication; and
send first indication information to the terminal, wherein the first indication information indicates the codebook used by the terminal.

22. A terminal, comprising:
a processor; and
a memory storing a computer program executable by the processor,
wherein the processor is configured to perform the method according to claim 11.

23-24. (canceled)
